(19) United States
(12) Patent Application Publication
(10) Pub. No.: US 2026/0252330 A1
(43) Pub. Date: Aug. 27, 2026

(54) USING A LARGE LANGUAGE MODEL TO TRANSLATE EXPANDABLE CODE IN A SOURCE PROGRAMMING LANGUAGE TO A TARGET PROGRAMMING LANGUAGE

(71) Applicant: INTERNATIONAL BUSINESS MACHINES CORPORATION, ARMONK, NY (US)

(72) Inventors: TAKAAKI TATEISHI, Yamato-shi (JP); YASUHARU KATSUNO, Hodogaya-ku (JP)

(21) Appl. No.: 19/063,581

(22) Filed: Feb. 26, 2025

(51) Int. Cl. G06F 8/51

(52) U.S. Cl. CPC G06F 8/51

(57) ABSTRACT

Provided are a computer implemented method, system and computer program product for using a large language model to translate expandable code in a source programming language to a target programming language. Expandable code in the source program in the source programing language is processed. A symbolic variable for a variable in the expandable code is generated into a code template providing a symbolic expression of the expandable code. A source-to-target language translator, for translating source programming language statements to target programming language statements, translates a definition statement in the target programming language defining the symbolic variable. A large language model, that generates code in the target programming language from symbolic statements, translates the symbolic expression in the code template to target programming language statements implementing the expandable code in the target program.

### BACKGROUND OF THE INVENTION

### 1. Field of the Invention

The present invention relates to a computer implemented method, system and computer program product for using a large language model to translate expandable code in a source programming language to a target programming language.

### 2. Description of Related Art

Large language models (LLMs) may be used to translate a program in one computer programming language to another. For instance, IBM®'s watsonx Code Assistant for Z is used to translate a program written in the COBOL computer language to Java®. This allows conversion of legacy COBOL code into functionally equivalent Java code. The older applications written in COBOL are translated to a more contemporary language while preserving the core business logic. This conversion process is often used for mainframe modernization projects where large amounts of COBOL code need to be updated. (Java is a trademark of Oracle Corporation throughout the world; IBM and watsonx Code Assistant are trademarks of International Business Machines Corporation throughout the world).

### SUMMARY

Provided are a computer implemented method, system and computer program product for using a large language model to translate expandable code in a source programming language to a target programming language. Expandable code in the source program in the source programing language is processed. A symbolic variable for a variable in the expandable code is generated into a code template providing a symbolic expression of the expandable code. A source-to-target language translator, for translating source programming language statements to target programming language statements, translates a definition statement in the target programming language defining the symbolic variable. A large language model, that generates code in the target programming language from symbolic statements, translates the symbolic expression in the code template to target programming language statements implementing the expandable code in the target program.

### BRIEF DESCRIPTION OF THE DRAWINGS

FIG. 1 illustrates an embodiment of a system for translating expandable code in a source programming language to a target programming language.

FIGS. 2A and 2B illustrate an embodiment of operations to translate expandable code in the source programming language to the target programming language.

FIGS. 3A, 3B, 4A, 4B, and 5 illustrate examples of how source programming language statements are translated to target programming language statements.

FIG. 6 illustrates a computing environment in which the components of FIG. 1 may be implemented.

### DETAILED DESCRIPTION

Certain legacy computer programs, such as PL/I® (“Programming Language 1”), include procedures, such as macros, that do not have a direct equivalent in modern computer languages such as Java. A macro comprises a single program statement that is expanded into a macro expansion comprising a sequence of code or other replacement output inserted into the program at the location of the macro statement. Expanding the macro procedures (a string manipulating program that generates a string value representing a PL/I code) loses modularity and maintainability of the code. An LLM program translator may not understand PL/I programs generated by macro procedures.

Described embodiments provide improvements to computer technology for translating a source programming language to a target programming language by providing for special handling of the macro variables. Described embodiments convert a macro procedure in the source programming language, such as the legacy PL/1 language, to a more modern target programming language, such as Java, by symbolically executing the macro procedures to create a code template providing symbolic values for the macro variables. The code template may be marked to indicate certain types of expansions, such as expansions of a while loop, to facilitate the merging of the LLM translated code blocks into a single code block comprising a while statement. The LLM may then be used to translate the symbolic expressions in the code template representing the expandable code, such as a macro statement or while loop, into the target programming language. Further, certain sections of the source program, such as definitions, may be translated by a source-to-target language translator that directly translates the program statements.

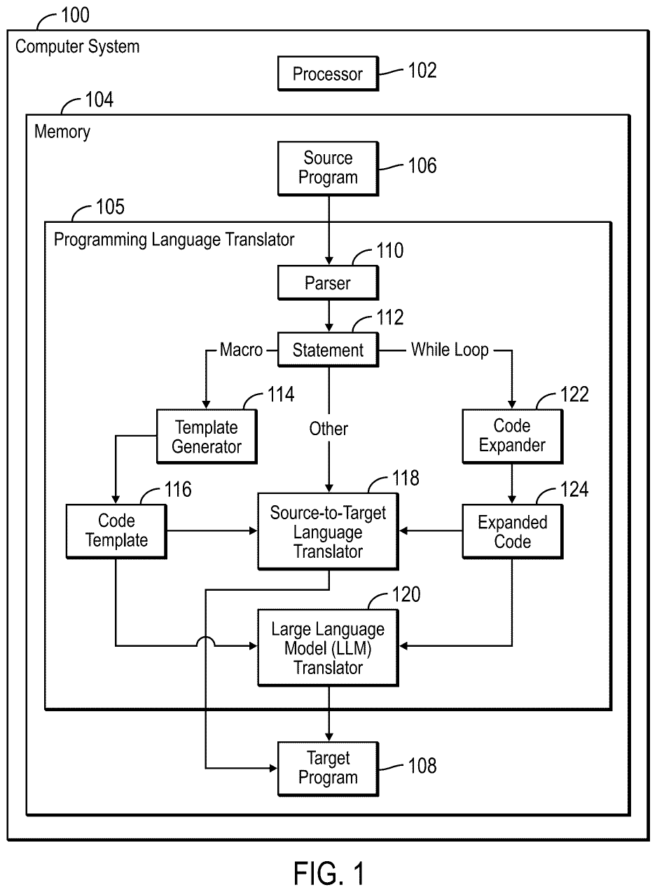

FIG. 1 illustrates an embodiment of a computer system 100 in which embodiments are implemented. The system 100 includes a processor 102 and a main memory 104. The main memory 104 includes a programming language translator 105 that receives a source program 106 in a source programming language to translate to a target program 108 in a target programming language. The source program 106 may be coded in a high level programming language, such as PL/I® (“Programming Language 1”). The target program 108 may comprise the source program 106 translated to another programming language such as Java®. (PL/I is a registered trademark of International Business Machines Corporation throughout the world; Java is a registered trademark of Oracle Corporation throughout the world)

A source language parser 110 extracts code statements 112 from the source program 106. The parser 110 processes statements 112 of blocks of code in the source program 106 to locate expandable code, such as macros and while loops, and other blocks of code. A while loop comprises a control flow statement that allows code to be executed repeatedly for a specific number of instances or based on a presence of a condition. A macro comprises a single program statement that is expanded into a macro expansion comprising a sequence of code or other replacement output inserted into the program at the location of the macro statement.

The parser 110 forwards macro statements to a template generator 114 that maps the macro expansion code in the source programming language to symbolic values comprising symbolic expressions of the variables, literals and operators in the macro expansion code. The template generator 114 outputs the definition statement and the symbolic expressions of the macro expansion to a code template 116. The definition statement of the macro in the source program 106 is processed by a source-to-target language translator 118 to generate the definition statement in the target programming language in the target program 108. A large language model (LLM) translator 120 translates the symbolic values and expressions in the code template 116 to target programming language statements implementing the same logic as the macro in the target program 108. The LLM translator 120 may comprise a machine learning model trained to convert symbolic expressions and a code template into the target programming language.

The parser 110 may forward while loop statements to a code expander 122. The code expander 122 expands the while loop statements into expanded code 124 for each instance the while loop is to run. The code expander 122 may mark each instance of the expanded while loop statement with a marker before and after the expanded while loop statements to assist the LLM translator 120 in merging the expanded while loop statements to a single while loop statement in the target programming language. Other types of statements not requiring expansions may be translated directly by the source-to-target language translator 118.

The memory 104 may comprise suitable volatile or non-volatile memory devices known in the art. For instance, the memory 104 may comprise one or more memory devices volatile or non-volatile, such as a Dynamic Random Access Memory (DRAM), a phase change memory (PCM), Magnetoresistive random-access memory (MRAM), Spin Transfer Torque (STT)-MRAM, SRAM storage devices, DRAM, a ferroelectric random-access memory (Efram), nanowire-based non-volatile memory, and Direct In-Line Memory Modules (DIMMs), NAND storage, e.g., flash memory, Solid State Drive (SSD) storage, non-volatile RAM, etc.

Generally, program modules, such as the program components 105, 106, 108, 110, 114, 116, 118, 120, 122, 124, among others, may comprise routines, programs, objects, components, logic, data structures, and so on that perform particular tasks or implement particular abstract data types. The program components and hardware devices of the system 100 may be implemented in one or more computer systems, where if they are implemented in multiple computer systems, then the computer systems may communicate over a network.

The program components 105, 106, 108, 110, 114, 116, 118, 120, 122, 124, among others, may be accessed by the processor 102 from the memory 104 to execute. Alternatively, some or all of the program components 105, 106, 108, 110, 114, 116, 118, 120, 122, 124 may be implemented in separate hardware devices, such as Application Specific Integrated Circuit (ASIC), Field Programmable Gate Arrays (FPGAs) and other hardware devices.

The functions described as performed by the program components 105, 106, 108, 110, 114, 116, 118, 120, 122, 124, among others, may be implemented as program code in fewer program modules than shown or implemented as program code throughout a greater number of program modules than shown.

Certain of the components, such as the LLM translator 120, may use machine learning algorithms, such as deep learning algorithms and natural language processor (NLP) algorithms to process text to produce a vector comprising a numerical representation of the text. Program components implementing machine learning models, such as LLM translator 120, may be implemented in an Artificial Intelligence (AI) hardware accelerator, such as an FPGA or a graphics processing unit (GPU).

In certain embodiments, the LLM translator 120 may use machine learning and deep learning algorithms, such as decision tree learning, generative AI, neural network, inductive programming logic, support vector machines, Bayesian network, Recurrent Neural Networks (RNN), Feedforward Neural Networks, Convolutional Neural Networks (CNN), Deep Convolutional Neural Networks (DCNNs), Generative Adversarial Network (GAN), etc.

For artificial neural network program implementations, the LLM translator 120 maybe trained using as input the source code, code template and symbolic values generated from the expandable code to produce as output the desired code in the target programming language. In certain embodiments, the LLM translator 120 may be trained using backward propagation to adjust weights and biases at nodes in a hidden layer to produce their output based on the received inputs. In backward propagation, biases at nodes in the hidden layer are adjusted accordingly to produce the output, such as code in the target programming language from input comprising the source program, code template, and symbolic expressions generated from expandable code, e.g., macros and while loops, in the source program, with specified confidence levels based on the input parameters. The LLM translator 120 may be trained to produce their output from feedback and based on the input. Backward propagation may comprise an algorithm for supervised learning of artificial neural networks using gradient descent to minimize the errors in predictions. Given a large language model artificial neural network and an error function, the method may use gradient descent to find the parameters (coefficients) for the nodes in a neural network or function that minimizes a cost function measuring the difference or error between actual and predicted values for different parameters. The parameters are continually adjusted during gradient descent to minimize the error.

In further embodiments, techniques other than backward propagation may be used to train the LLM translator using the source code, code template, and symbolic expressions generated from expandable code.

The arrows shown in FIG. 1 between the components in the memory 104 represent a data flow between the components.

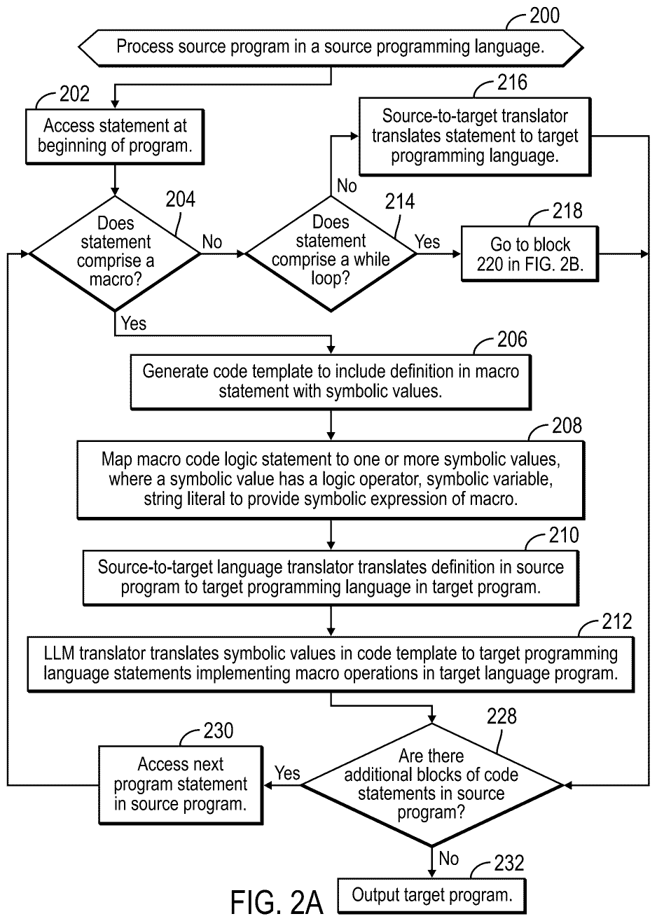

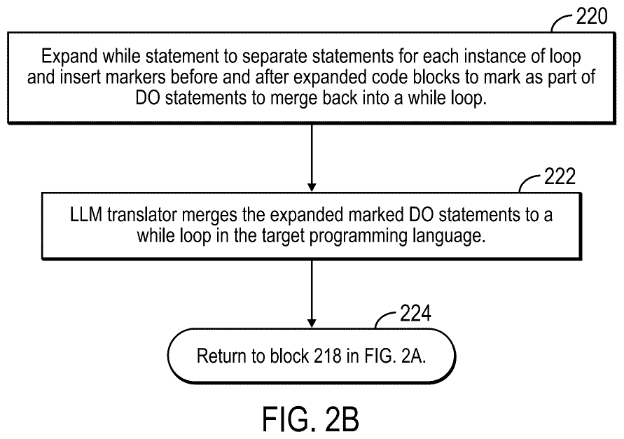

FIGS. 2A and 2B illustrate an embodiment of operations to translate statements in a source program, in a source programming language, to a target program, in a target programming language, using a source-to-target language translator, e.g., 118, a LLM translator, e.g., 120, parser, e.g., 110, template generator, e.g., 114, and code expander, e.g., 122. Upon processing (at block 200) a source program in a source programming language, the parser accesses (at block 202) a statement at the beginning of the program, such as an instruction or block of grouped instructions to accomplish a task. If (at block 204) the accessed statement comprises a macro, then a template generator generates (at block 206) a code template, such as 116, including the macro definition with symbolic values representing variables in the macro statement. The template generator further maps (at block 208) code logic in the macro statement to one or more symbolic values, where a symbolic value has a logic operator, symbolic variable, string literal as a symbolic expression of the macro operations. These symbolic values may allow for symbolic execution of the macro code in the source programming language.

The source-to-target language translator translates (at block 210) the definition statement in the source programming language in the source program to a target programming language in the target program. The LLM translator may translate (at block 212) symbolic values in the code template to statements in the target programming language implementing the macro in the target program.

If (at block 204) the statement does not comprise a macro and does not comprise (at block 214) a while loop, then the source-to-target translator translates (at block 216) the while statement, with a fixed number of iterations, to the target programming language in the target program. If (at block 214) the accessed statement comprises a while loop, then control proceeds (at block 218) to block 220 in FIG. 2B to translate the while loop statement.

At block 220 in FIG. 2B, the code expander expands the while loop statements to separate instances of the statements in the while loop for each instance the while loop runs. The code expander may further insert markers before and after the expanded code blocks to indicate the statements as part of DO statements to merge back into a while loop. The LLM translator translates (at block 222) the expanded marked DO statements to a while loop in the target programming language in the target program by merging the expanded marked DO statements into a single while loop statement in the target programming language. Control returns (at block 224) to block 218 in FIG. 2A.

From block 212, 216 or 218, if (at block 228) there are further blocks of code statements in the source program, then the parser accesses (at block 230) the next program statement in the source program and control returns to block 204 to process the next program statement. If (from the NO branch of block 228) all statements in the source program have been translated to target programming language in the target program, then the target program is outputted (at block 232) to storage or a debugger program for further processing. The target program may be subject to debugging and testing. After the target program is suitably tested, it may be compiled and converted to executable code to be deployed as an application.

With the embodiment of FIGS. 2A and 2B, expandable code in a target programming language, such as macro statements and while loop statements, may be expanded into symbolic expressions and symbolic values and then processed by an LLM translator to convert the symbolic expressions to target programming language code. Definition statements and non-expandable statements may be translated directly by the source-to-target language translator. In this way, described embodiments provide improved technology for translating source programming language statements requiring expansion to target programming language statements that may not be handled correctly by a source-to-target translator. Especially in cases of macros where the target programming language may not provide for macros.

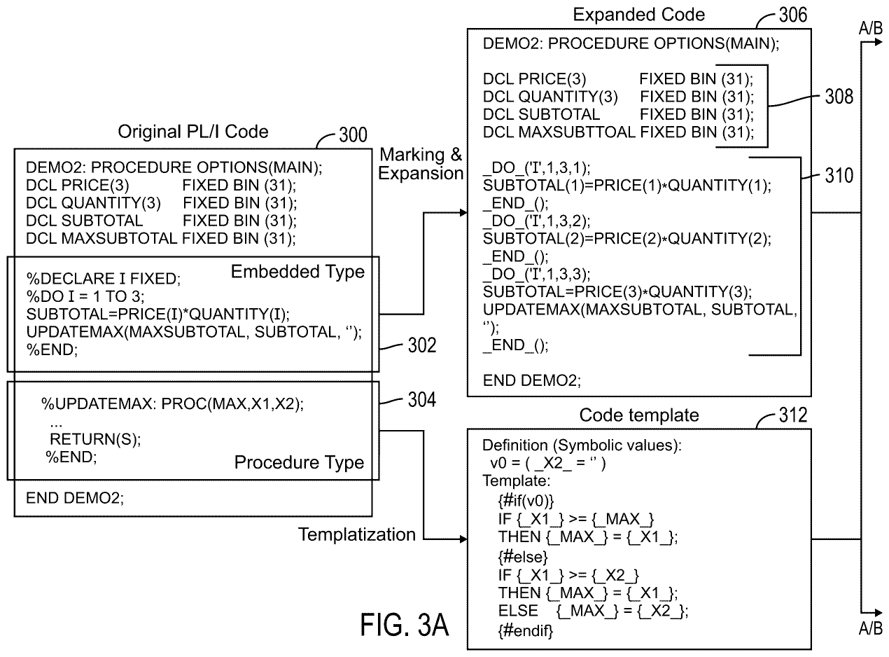

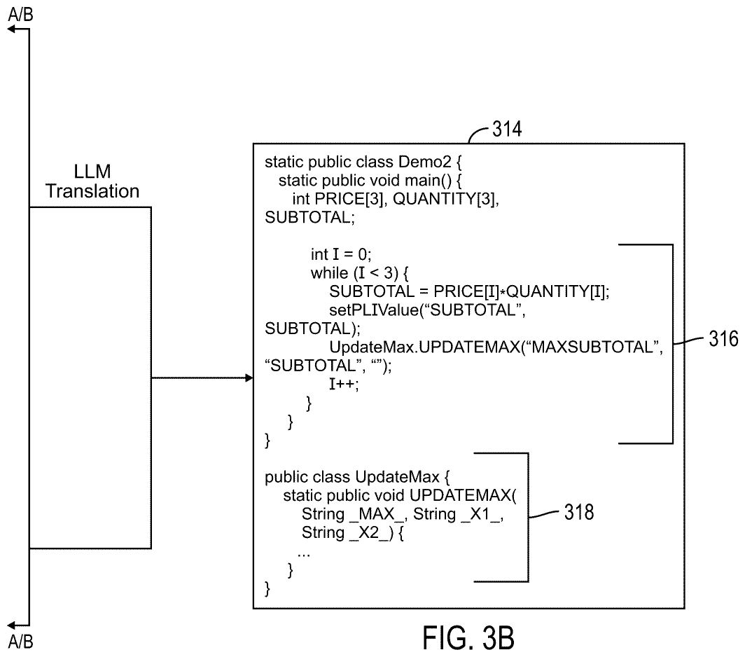

FIGS. 3A and 3B illustrates an example of how source PL/I code 300 having a while loop 302 denoted by the DO statement and a macro 304 procedure called UPDATEMAX are translated to Java code 314. The while loop 302 is expanded into expanded code 306 including the definition 308 and expanded while loop 310. The macro 304 is expanded into a code template 312 having symbolic values, including symbolic variables “X1” , “_MAX”, “_X2”, and symbolic logic IF-THEN-ELSE operators, comprising a symbolic expression of the macro 304. The LLM translator may translate the expanded while loop 310 and the code template 312 to target code 314 in in the Java programming language. For instance, the LLM translator translates the symbolic expressions of the while loop 310 in the expanded code to the while block of Java code 316. The source-to-target language translator may translate the definition of the macro 304 to the definition in macro 318 and translate the definitions of PL/I code 300 to definitions in Java 314.

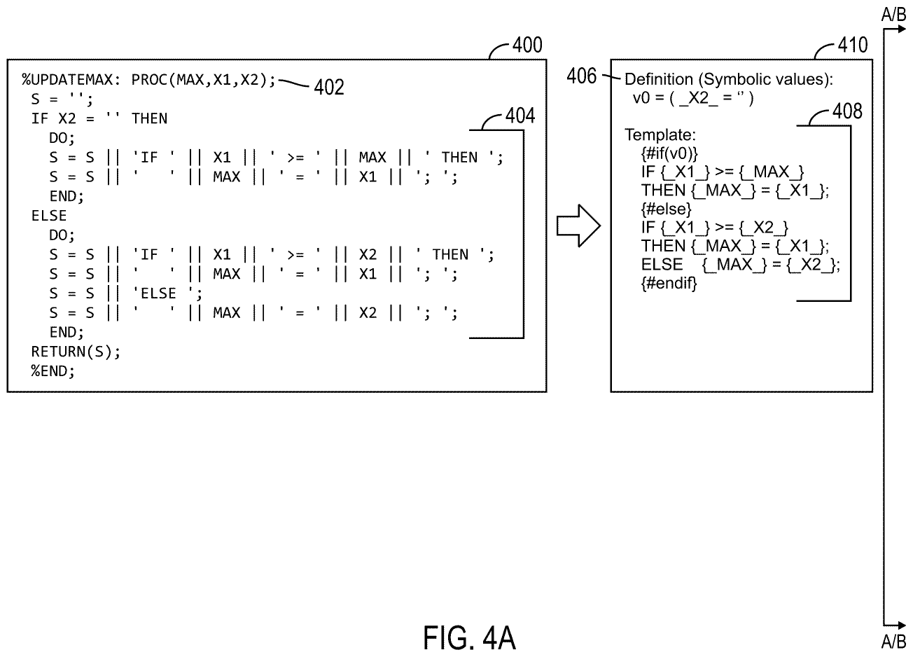

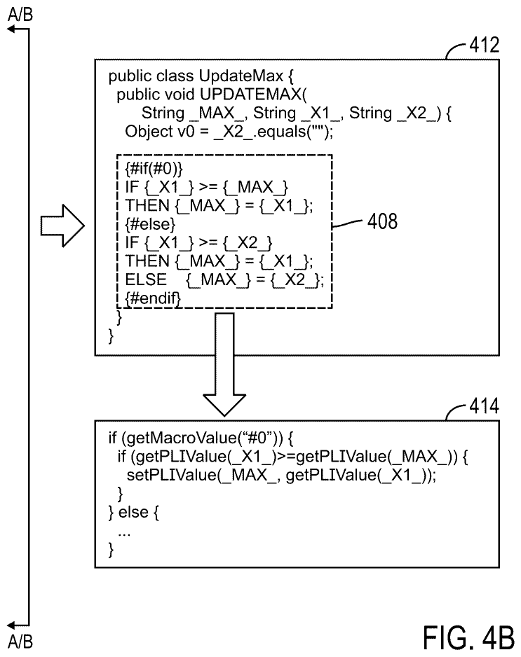

FIGS. 4A and 4B provides a further example of how PL/I source code 400 having a macro UPDATEMAX definition 402 and an if-then-else statement block 404. The template generator translates the definition 402 and the if-then-else statement block 404 to definition statement 406 and symbolic expressions 408, respectively, in the code template 410. A PL/I-to-Java translator may translate the definition statement 406 to a Java definition statement 412. The LLM translator may translate the template block 408 of expanded macro symbolic values 408 to Java code 414.

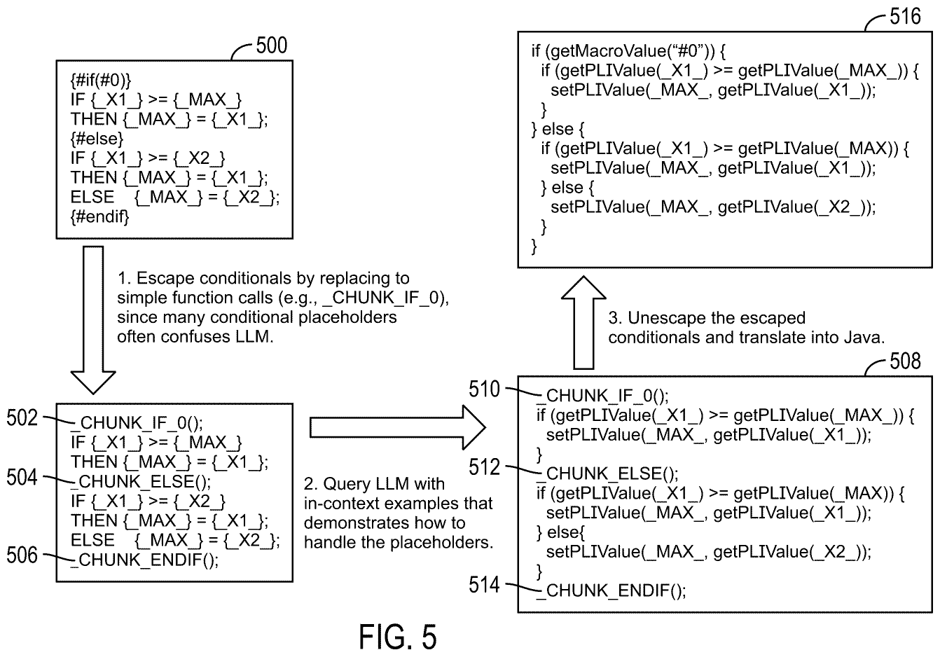

FIG. 5 provides an additional example of how the template generator may add to the code template 500 symbolic values with escape conditionals 502, 504, 506 to the function calls of the if-then-else statements, e.g., “_CHUNK_”. These escape conditionals provide information to the LLM translator on how to handle placeholders to translate the if-then-else statements to if-then-else statements in the target programming language, e.g., Java. The LLM translator may translate the if-then-else statements with the escape conditionals to Java code 508 having the “_CHUNK_” escape conditionals 510, 512, 514. The LLM translator may then remove the escape conditionals 510, 512, 514 to produce the final Java code 516.

In certain embodiments, a symbolic value may be represented as a list of string literals, variables and special values. For instance, for an if-then-else statement, the special value may comprise (“if”, v), (“else”), (“endif”). For a function call F, the symbolic value may comprise a list of (“F”, v1, v2, v3) where v, v1, v2, and v3 are variables and F is a function name.

A symbolic value may be a list of string literals (e.g., “My”, “20”) or variables (e.g., _VAR_, _VAL_). For instance, [“My”, _VAR_, “=”, “20”] is a symbolic value which may be represented by “My{_VAR_}=20” in the code template. If the first statement is in the form X=s, where X is a variable and s is a string literal, then the mapping of X=s takes the form of D[X]=[s] (set the value of D[X] to [s]), where D[] denotes a mapping.

In another example, if s is “MyA=MyB”, then the mapping comprises D[X]=[“MyA=MyB”]. In the code template, [“MyA=MyB”] is simply represented by “MyA=MyB”, which is then translated to the Java code: setPLIValue(“MyA”, getPLIValue(“MyB”)).

If the statement comprises a concatenation statement (“∥”), such as in the form X=X1∥X2, then the mapping comprises D[X]=D[X1]+D[X2]. For example, if D[X1]=[“My”, _VAR_], D[X2]=[“=”, _VAL_], then D[X]=[“My”, _VAR_, “=”, _VAL_]. In the symbolic expression in the code template, [“My”, _VAR_, “=”, VAL_] is represented by “My{_VAR_}={VAL_}”. This symbolic expression is then translated into a set command in Java to set the variable to the value and a get command in Java to get the value, such as the following Java code: setPLIValue(“My”+_VAR_, getPLIValue(_VAL_)).

If the source statement is in the form X=F(X1, . . . ) , where F is a function, then the mapping comprises D[X]=[(“F”, D[X1], . . . )]. For example, if D[X1]=[“My”, _VAR_], then the symbolic mapping comprises D[X]=[(“f”, [“My”, _VAR_])]. In the symbolic expression in the code template, [(“f”, [“My”, _VAR_])] is represented by “F(My{_VAR_})”. The LLM translator translates this symbolic expression to Java code comprising: f(getPLIValue(“My”+_VAR_)), where f is a Java method corresponding to the PL/I function F (e.g., substring extraction).

If the statement in the source programming language is in the form IF-THEN-ELSE statements, then symbolically execute then-statements and else-statements, respectively, with mapping copies D′ and D″ of D. If a variable X is updated only in the then-statement upon satisfying a condition, then the mapping to the symbolic expression comprises D[X]=[(“if”, #n)]+D′[X]+[(“endif”)] where #n is the sequence number of a symbolic value assigned to v. If a variable X is updated only in else-statement when the condition is not satisfied, then the mapping to the symbolic expression comprises D[X]=[(“if”,#n), (“else”)]+D″[X}. If a variable X is updated in both then and else statements, then the mapping too the symbolic expression comprises, D[X]=[(“if”, #n)]+D′[X]+[(“else”)]+D″[X]+[(“endif”)].

For example, if there is a statement IF FLAG THEN S=X∥“=1” ELSE S=X∥“=0”, then the mapping comprises D[X]=[“My”, _VAR_] and D[X]=[(“if”, #1), “My”, _VAR_, “=1”, (“else”), “My”, _VAR_, “=0”, (“endif”)]. The symbolic value may be represented by “{#if(#1)}My{_VAR_}=1{#else}My{_VAR_}=0{#endif}”. The LLM translator translates the symbolic expression to an if-then-else statement followed by a first set command in the target programming language, such as Java, to set a variable for the symbolic variable to the first literal value if the condition is satisfied, and to an else statement followed by a second set command in the target programming language to set the variable to the second literal value if the condition is not satisfied. An example of this translation of the symbolic value to the Java code comprises: if(v1){setPLIValue(My+_VAR_, 1)} else {setPLIValue(My+_VAR_, 0)}.

The present invention may be a system, a computer implemented method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

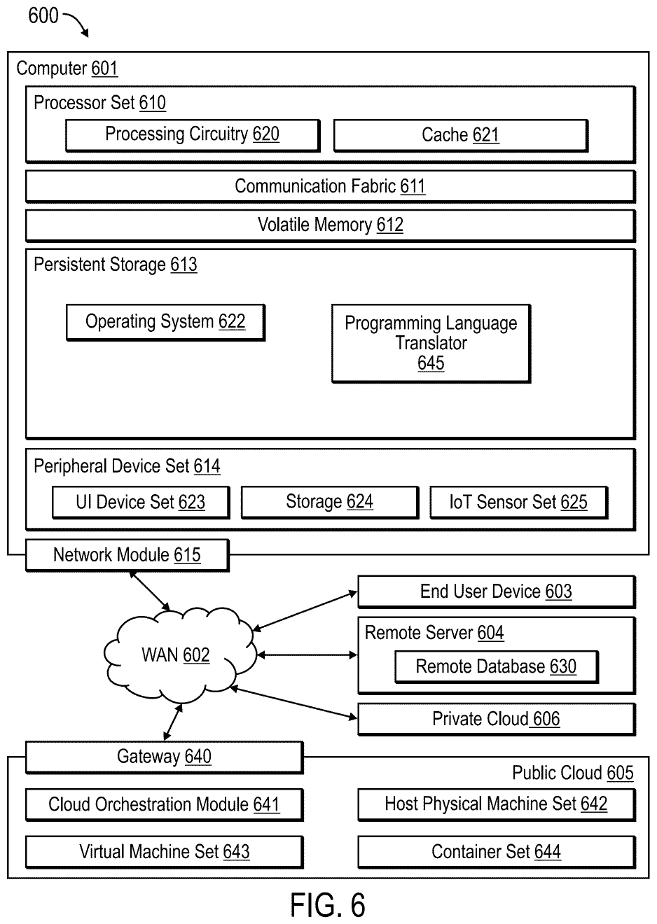

With respect to FIG. 6, computing environment 600 contains an example of an environment for the execution of at least some of the computer code involved in performing the inventive methods, such as the programming language translator 645. Programming language translator may comprise programming language translator 105 in FIG. 1, as described above, to translate a source program to a target program. The computing environment 600 may further include, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and the programming language translator 645, as identified above), peripheral device set 614 (including user interface (UI) device set 623, storage 624, and Internet of Things (IOT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 645 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The programming language translator 645 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The letter designators, such as i and j, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer implemented method for translating a source program in a source programming language to a target program in a target programming language, comprising:
processing expandable code in the source program in the source programing language;
generating a symbolic variable for a variable in the expandable code into a code template providing a symbolic expression of the expandable code;
translating, by a source-to-target language translator for translating source programming language statements to target programming language statements, a definition statement in the target programming language defining the symbolic variable; and
translating, by a large language model that generates code in the target programming language from symbolic statements, the symbolic variable in the code template to target programming language statements implementing the expandable code in the target program.

2. The computer implemented method of claim 1, further comprising:
processing a while loop, in the source programming language, for a fixed number of iterations in the source program;
expanding the while loop for each iteration of the iterations into statements with symbolic variables in the while loop; and
merging, by the large language model, the statements with the symbolic variables into a while loop in the target programming language in the target program.

3. The computer implemented method of claim 2, further comprising:
inserting markers before the statements for the while loop, wherein the large language model processes the markers to merge the statements with the symbolic variables to the while loop in the target programming language.

4. The computer implemented method of claim 1, wherein the expandable code in the source program comprises a macro, wherein the operations of translating the definition statement in the macro, the generating the symbolic variable and the translating the symbolic variable are performed for each instance of the macro in the source program.

5. The computer implemented method of claim 1, further comprising:
processing the source program to generate a mapping from the variable in the expandable code to symbolic values, wherein the symbolic values comprises a list of a string literal, the symbolic variable, and an operator indicating an operation to be performed with respect to the symbolic variable and the string literals in the expandable code, wherein the large language model translates the symbolic values comprising the list of the string literal, the symbolic variable and the operator to the target programming language statements implementing the expandable code.

6. The computer implemented method of claim 1, wherein the expandable code comprises a macro to set the variable to a string literal, further comprising:
processing the macro in the source program to generate a symbolic expression to set the symbolic variable to the string literal in the code template.

7. The computer implemented method of claim 1, wherein the expandable code comprises a macro to concatenate the variable and a value, further comprising:
processing the macro in the source program to generate symbolic values representing a concatenate operation including the symbolic variable and the value, wherein the large language model translates the symbolic values to a set command in the target programming language to set the variable to the value and a get command in the target programming language to get the value.

8. The computer implemented method of claim 1, wherein the expandable code comprises a macro comprises a function performed with respect to a variable, further comprising:
processing the macro in the source program to generate a symbolic expression including a function symbol representing the function and a symbolic variable representing the variable in the macro, wherein the large language model translates the function symbol and the symbolic variable to a get command, in the target programming language, to get a value for the variable within a method in the target programming language.

9. The computer implemented method of claim 1, wherein the expandable code comprises a macro including an if-then-else statement with respect to a variable, further comprising:
processing the macro in the source program to generate a symbolic expression including an if statement, followed by a symbolic variable, a condition, and a first literal value to which to set the symbolic variable if the condition is satisfied, and an else statement followed by a second literal value to which to set the symbolic variable, wherein the large language model translates the symbolic expression to an if-then-else statement followed by a first set command in the target programming language to set a variable for the symbolic variable to the first literal value if the condition is satisfied, and to an else statement followed by a second set command in the target programming language to set the variable to the second literal value if the condition is not satisfied.

10. The computer implemented method of claim 9, wherein the symbolic expression includes a sequence number of the symbolic variable in the if-then-else statement.

11. A computer system for translating a source program in a source programming language to a target program in a target programming language comprising:
a processor set;
one or more computer-readable storage media; and
program instructions stored on the one or more computer-readable storage media to cause the processor set to perform operations comprising:
processing expandable code in the source program in the source programing language;
generating a symbolic variable for a variable in the expandable code into a code template providing a symbolic expression of the expandable code;
translating, by a source-to-target language translator for translating source programming language statements to target programming language statements, a definition statement in the target programming language defining the symbolic variable; and
translating, by a large language model that generates code in the target programming language from symbolic statements, the symbolic variable in the code template to target programming language statements implementing the expandable code in the target program.

12. The computer system of claim 11, wherein the operations further comprise:
processing a while loop, in the source programming language, for a fixed number of iterations in the source program;
expanding the while loop for each iteration of the iterations into statements with symbolic variables in the while loop; and
merging, by the large language model, the statements with the symbolic variables into a while loop in the target programming language in the target program.

13. The computer system of claim 11, wherein the expandable code in the source program comprises a macro, wherein the operations of translating the definition statement in the macro, the generating the symbolic variable, and the translating the symbolic variable are performed for each instance of the macro in the source program.

14. The computer system of claim 11, wherein the operations further comprise:
processing the source program to generate a mapping from the variable in the expandable code to symbolic values, wherein the symbolic values comprises a list of a string literal, the symbolic variable, and an operator indicating an operation to be performed with respect to the symbolic variable and the string literals in the expandable code, wherein the large language model translates the symbolic values comprising the list of the string literal, the symbolic variable and the operator to the target programming language statements implementing the expandable code.

15. The computer system of claim 11, wherein the expandable code comprises a macro including an if-then-else statement with respect to a variable, wherein the operations further comprise:
processing the macro in the source program to generate a symbolic expression including an if statement, followed by a symbolic variable, a condition, and a first literal value to which to set the symbolic variable if the condition is satisfied, and an else statement followed by a second literal value to which to set the symbolic variable, wherein the large language model translates the symbolic expression to an if-then-else statement followed by a first set command in the target programming language to set a variable for the symbolic variable to the first literal value if the condition is satisfied, and to an else statement followed by a second set command in the target programming language to set the variable to the second literal value if the condition is not satisfied.

16. A computer program product for translating a source program in a source programming language to a target program in a target programming language, comprising:
one or more computer-readable storage media; and
program instructions stored on the one or more computer-readable storage media to perform operations comprising:
processing expandable code in the source program in the source programing language;
generating a symbolic variable for a variable in the expandable code into a code template providing a symbolic expression of the expandable code;
translating, by a source-to-target language translator for translating source programming language statements to target programming language statements, a definition statement in the target programming language defining the symbolic variable; and
translating, by a large language model that generates code in the target programming language from symbolic statements, the symbolic variable in the code template to target programming language statements implementing the expandable code in the target program.

17. The computer program product of claim 16, wherein the operations further comprise:
processing a while loop, in the source programming language, for a fixed number of iterations in the source program;
expanding the while loop for each iteration of the iterations into statements with symbolic variables in the while loop; and
merging, by the large language model, the statements with the symbolic variables into a while loop in the target programming language in the target program.

18. The computer program product of claim 16, wherein the expandable code in the source program comprises a macro, wherein the operations of translating the definition statement in the macro, the generating the symbolic variable, and the and the translating the symbolic variable are performed for each instance of the macro in the source program.

19. The computer program product of claim 16, wherein the operations further comprise:
processing the source program to generate a mapping from the variable in the expandable code to symbolic values, wherein the symbolic values comprises a list of a string literal, the symbolic variable, and an operator indicating an operation to be performed with respect to the symbolic variable and the string literals in the expandable code, wherein the large language model translates the symbolic values comprising the list of the string literal, the symbolic variable and the operator to the target programming language statements implementing the expandable code.

20. The computer program product of claim 16, wherein the expandable code comprises a macro including an if-then-else statement with respect to a variable, wherein the operations further comprise:
processing the macro in the source program to generate a symbolic expression including an if statement, followed by a symbolic variable, a condition, and a first literal value to which to set the symbolic variable if the condition is satisfied, and an else statement followed by a second literal value to which to set the symbolic variable, wherein the large language model translates the symbolic expression to an if-then-else statement followed by a first set command in the target programming language to set a variable for the symbolic variable to the first literal value if the condition is satisfied, and to an else statement followed by a second set command in the target programming language to set the variable to the second literal value if the condition is not satisfied.
